(19) United States
(12) Patent Application Publication
(10) Pub. No.: US 2026/0172262 A1
(43) Pub. Date: Jun. 18, 2026

(54) INFORMATION PROCESSING DEVICE AND INFORMATION PROCESSING METHOD

(71) Applicant: KABUSHIKI KAISHA TOSHIBA, Kawasaki-shi Kanagawa (JP)

(72) Inventor: Tomoko YONEMURA, Kawasaki Kanagawa (JP)

(73) Assignee: KABUSHIKI KAISHA TOSHIBA, Kawasaki-shi Kanagawa (JP)

(21) Appl. No.: 19/308,535

(22) Filed: Aug. 25, 2025

(30) Foreign Application Priority Data
Dec. 17, 2024 (JP) 2024-221063

(51) Int. Cl. H04L 9/32; H04L 9/30

(52) U.S. Cl. CPC H04L 9/3247; H04L 9/3093; H04L 9/3236

(57) ABSTRACT

According to one embodiment, an information processing device includes: a first calculator configured to calculate first polynomial expressions from a seed, for X elements of a plurality of elements in a matrix; a first storage configured to store the first polynomial expressions calculated by the first calculator; and a signature candidate generator configured to sequentially select the plurality of elements. The signature candidate generator, when the selected element is one of the X elements, reads the corresponding first polynomial expression from the first storage and performs computation based on the first polynomial expression. The signature candidate generator, when the selected element is one of Y elements other than the X elements, calculates a second polynomial expression for the selected element from the seed and performs computation based on the second polynomial expression. The signature candidate is generated based on the result of the computation.

### CROSS REFERENCE TO RELATED APPLICATIONS

This application is based upon and claims the benefit of priority from the prior Japanese Patent Application No. 2024-221063, filed on Dec. 17, 2024, the entire contents of which are incorporated herein by reference.

### FIELD

Embodiments described herein relate to an information processing device and an information processing method.

### BACKGROUND

In recent years, the research on a quantum computer has been accelerated by the entry of major information technology (IT) companies. When a quantum computer that decodes an RSA encryption and an elliptic curve cryptography, which are public-key encryptions widely used today, is realized, information security systems that use the RSA encryption and the elliptic curve cryptosystem become unsafe. Hence, the research and development on a Post-Quantum Cryptography (also referred to as a Quantum-Safe Cryptography or a Quantum-Resistant Cryptography) has been promoted in preparation for a case where the transition from the RSA encryption and the elliptic curve cryptosystem to the PQC is needed.

As a major candidate for the Post-Quantum Cryptography, there are a lattice-based encryption and a lattice-based digital signature that have safety based on a LWE (Learning with Errors) problem. For example, as standard schemes of the Post-Quantum Cryptography according to NIST (National Institute of Standards and Technology), there are ML-KEM (Module-Lattice-Based Key-Encapsulation Mechanism) and ML-DSA (Module-Lattice-Based Digital Signature Algorithm). In ML-KEM and ML-DSA, a seed for a matrix is held as a part of a public key. In cryptographic processing, coefficients of polynomial expressions that are elements of the matrix are calculated from the seed, the matrix having the polynomial expressions as the elements is held, and a matrix computation and a polynomial expression computation are executed.

The lattice-based encryption and the lattice-based digital signature have an advantage that the balance between the key size and the execution cycle count is more excellent compared to a code-based cryptography and an Isogeny-based Cryptography that are other PQCs, but have a disadvantage that a memory size to be used for cryptographic processing such as key generation, encryption, decryption, key encapsulation, key decapsulation, signature generation, or signature verification is larger compared to the key size. This is because holding the matrix to be used for the cryptographic processing as the seed in the public key in the case of the lattice-based encryption and the lattice-based digital signature is performed for the purpose of the reduction in communication volume and storage size and does not contribute to the reduction in the memory size necessary at the time of the execution of the cryptographic processing.

For memory saving for the reduction in the memory size necessary at the time of the execution of the cryptographic processing, there has been proposed a streaming process in which the whole of the matrix is not held when the matrix is obtained from the seed in the cryptographic processing and a part of the matrix is held in units of a row or column of the matrix, in units of a polynomial expression that is a matrix element, or in units of a coefficient included in a polynomial expression that is a matrix element (that is, in units of a “a coefficient of ‘a polynomial expression that is a matrix element’”). Meanwhile, a signature generation process has a repetitive structure in which a signature candidate is generated, whether a condition is satisfied is determined, and the generation of the signature candidate is repeated depending on the determination result. The matrix is used in the interior of the repetitive structure, and therefore, when the streaming process is simply applied, there is a problem in that a process of calculating the coefficient of the polynomial expression that is the element of the matrix from the seed is repeated and an execution cycle count overhead becomes large.

### BRIEF DESCRIPTION OF THE DRAWINGS

FIG. 1 is a functional block diagram of a digital signature generation device as an information processing device according to an embodiment 1;

FIG. 2 is a diagram showing the correspondence relation between processes to be performed by units of the digital signature generation device and codes in a pseudo code E1;

FIG. 3 is a flowchart showing an example of the operation of the digital signature generation device according to the embodiment 1;

FIG. 4 is a diagram showing the correspondence relation between processes to be performed by units of the digital signature generation device and codes in a pseudo code E2;

FIG. 5 is a flowchart showing an example of the operation of a digital signature generation device according to an embodiment 2;

FIG. 6 shows an example of an operation sequence that is performed between a client and a server;

FIG. 7 is a flowchart showing a process that is performed by the execution of a pseudo code P1; and

FIG. 8 is a diagram showing a computer device as a hardware configuration of an information processing device according to an embodiment of the present invention.

### DETAILED DESCRIPTION

According to one embodiment, an information processing device includes: a first calculator configured to calculate first polynomial expressions from a seed, for X elements of a plurality of elements in a matrix; a first storage configured to store the first polynomial expressions calculated by the first calculator; and a signature candidate generator configured to sequentially select the plurality of elements. The signature candidate generator, when the selected element is one of the X elements, reads the corresponding first polynomial expression from the first storage and performs computation based on the first polynomial expression. The signature candidate generator, when the selected element is one of Y elements other than the X elements, calculates a second polynomial expression for the selected element from the seed and performs computation based on the second polynomial expression. The signature candidate is generated based on the result of the computation.

Embodiments of the present invention will be described below with reference to the drawings. Embodiments of the present invention relate to a technique for restraining a memory size to be used and an overhead (execution cycle count) for processing in a signature generation process including a repetitive structure for signature candidate generation.

Before the description of the embodiments, a comparative example 1 and comparative example 2 for the embodiments will be described below.

### Comparative Example 1

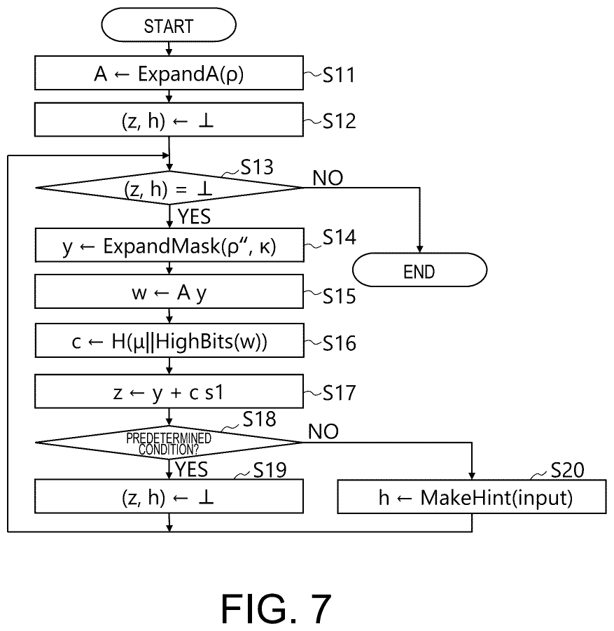

As an algorithm relevant to a lattice-based digital signature, there is ML-DSA (Module-Lattice-Based Digital Signature Algorithm), which is described in the “Module-Lattice-Based Digital Signature Standard” available at https://csrc.nist.gov/pubs/fips/204/final). An example of a pseudo code in which a part of a signature generation process “ML_DSA.Sign_internal” in ML-DSA shown in the “Module-Lattice-Based Digital Signature Standard” is simplified is shown below as a pseudo code P1. In the pseudo code P1, a code including a spot of a process that is a main object of memory saving in the “ML_DSA.Sign_internal” is simplified. Numbers on the left side are line numbers. A process that is performed by the execution of the pseudo code P1 is shown in FIG. 7, in the form of a flowchart.

(Pseudo Code P1)

| | |
|---|---|
| 01: | A ← ExpandA(ρ) |
| 02: | (z, h) ← ⊥ |
| 03: | while (z, h) = ⊥ do |
| 04: | y ← ExpandMask(ρ″, κ) |
| 05: | w ← A y |
| 06: | c ← H(μ∥HighBits(w)) |
| 07: | z ← y + c s1 |
| 08: | if predetermined condition then (z, h) ← ⊥ |
| 09: | else |
| 10: | h ← MakeHint(input) |
| 11: | end if |
| 12: | end while |

### Definition of Symbols

⊥: blank symbol indicating no value
ρ, ρ″: seed
κ: counter value
μ: message
A: matrix
z, h, y, w, s1: vector
c: polynomial expression
←: operator showing assignment
=: equality operator showing comparison of whether two values are equal
H: hash function
∥: operator showing concatenation

In the pseudo code P1, “predetermined condition” on the eighth line, “input” on the tenth line, and a function “ExpandMask”, a function “HighBits”, and a function “MakeHint” that are included in the pseudo code P1 are not related to the essence of the embodiments, and therefore, will be described below to the extent necessary, and detailed descriptions will be omitted. For details, see the “Module-Lattice-Based Digital Signature Standard”.

In step S11 (corresponding to the first line in the pseudo code P1) in FIG. 7, the matrix “A” is acquired from the seed “ρ”. Specifically, in the function “ExpandA”, coefficients of a polynomial expression are calculated for each element of the matrix “A”, by adopting the seed “ρ” as an input, and the calculated coefficients of the polynomial expression are held. Thereby, the matrix “A” including the polynomial expression as the element is held. The function “ExpandA” is a hash function, and the calculation of the hash function includes an absorption process of absorbing the seed “ρ” in the internal state as a part of a process for the hash function and a squeeze process of squeezing a hash value from the internal state as another process for the hash function. The seed “ρ” is generated using a predetermined function from a private key that is used for giving a signature. For example, the seed “ρ” is obtained by inputting the private key to a decode function (a “skDecode” function (see the “Module-Lattice-Based Digital Signature Standard”)).

As an example, suppose that the matrix “A” is a k-by-I matrix, that is, has a (k, l) dimension, the polynomial expression has 0-order to (n−1)-order coefficients (n coefficients), and each coefficient is stored in a 32-bit (4-byte) variable. In this case, for holding the matrix “A”, k×l×n×32 bits (k×l×n×4 bytes) are necessary, because the coefficients of the polynomial expression are held for each element. In security category 5 for ML-DSA, because of k=8, l=7, and n=256, 57344 bytes are necessary for holding the matrix “A”.

In step S12 (corresponding to the second line in the pseudo code P1), each of the vector “z” and the vector “h” are set to blank.

Steps S13 to S20 (the third to twelfth lines in the pseudo code P1) constitute a repetitive structure for signature candidate generation. In step S13 (corresponding to the third line in the pseudo code P1), whether the vector “z” and the vector “h” are blank is determined. In the case of being blank (YES), the process proceeds to step S14 (corresponding to the fourth line in the pseudo code P1), and in the case of being not blank (NO), the process ends (corresponding to the twelfth line in the pseudo code P1).

In steps S14 to S17 (corresponding to the fourth to seventh lines in the pseudo code P1), a signature candidate is generated. On the fourth line, the vector “y” is acquired by the function “ExpandMask”, by adopting “(ρ”, κ)” as an input. Here, “ρ″” is a seed that is calculated from data that is a signature object and a private key, using a predetermined function (for example, a function “H” in the “Module-Lattice-Based Digital Signature Standard”). Further, “κ” is a counter value, and the value is incremented depending on the number of repetitions.

In step S18 (corresponding to the eighth line in the pseudo code P1), whether a predetermined condition relevant to the signature candidate is satisfied is determined. The predetermined condition is a condition based on the vectors “w” and “z” and the polynomial expression “c”.

In the case where the predetermined condition is satisfied in step S18 (YES), the vector “z” and the vector “h” are set to blank in step S19, and the process returns to step S13. In this way, the generation of the signature candidate is repeated by repeating step S14 to step S17.

In the case where the predetermined condition is not satisfied on the eight line (NO), the process proceeds to step S20 (corresponding to the tenth line in the pseudo code P1), and the vector “h” is calculated by calculating the “MakeHint” function. Information based on the polynomial expression “c” and the vector “w” is used as an input of the “MakeHint” function. When the vector “h” is calculated, the process ends after NO in step S13.

Thereafter, a signature “(c, z, h)” is obtained using “c”, “z”, and “h” calculated by the computation of the pseudo code P1. More specifically, a bit string (byte string) showing a digital signature is obtained by inputting “c”, “z”, and “h” to an encode function (a “sigEncode” function).

The matrix “A” that is used on the fifth line in the pseudo code P1 is a main object of the memory saving in the embodiments. The vector “y” on the fourth line, the vector “z” on the seventh line, and the vector “h” on the tenth line also can be objects of the memory saving. However, here, descriptions will be made with a focus on the matrix “A”.

The first line in the pseudo code P1 is executed just one time, in the exterior of the repetitive structure for the signature candidate generation, and thereby, the matrix “A” is generated, and is held in a memory (storage). On the fifth line in the pseudo code P1, the held matrix “A” is read from the memory, and various computations (a matrix computation and a polynomial expression computation) are executed. The matrix “A” continues to be held in the memory, while the repetitive process in the signature generation process is executed. A memory size (for example, 57344 bytes) necessary for holding the matrix “A” is sufficiently larger than the size (for example, 32 bytes) of the seed “ρ”, and accordingly, it is found that the memory size necessary for the signature generation process is extremely larger than the key size.

### Comparative Example 2: Streaming Process

In a comparative example 2, for reducing (saving the memory) the memory size for holding the matrix “A” compared to the comparative example 1, the whole of the matrix “A” is not held, and a part of the matrix “A” is held in units of a row or column of the matrix “A”, in units of a polynomial expression (in units of a matrix element), or in units of a coefficient of a polynomial expression that is a matrix element. The generation of the signature candidate is performed by successively performing various computations while repeatedly updating and holding a part of the matrix “A”. Such a process is referred to as a streaming process. An example of a pseudo code in an algorithm using the streaming process will be described below as a pseudo code P2.

(Pseudo Code P2)

| | |
|---|---|
| 01: | (z, h) ← ⊥ |
| 02: | while (z, h) = ⊥ do |
| 03: | y ← ExpandMask(ρ″, κ) |
| 04: | for r from 0 to k−1 do |
| 05: | w[r] ← 0 |
| 06: | for s from 0 to l−1 do |
| 07: | ρ′ ← ρ∥s∥r |
| 08: | a ← RejNTTPoly(ρ′) |
| 09: | w[r] ← w[r] + a y[s] |
| 10: | end for |
| 11: | end for |
| 12: | c ← H(μ∥HighBits(w)) |
| 13: | z ← y + c s1 |
| 14: | if predetermined condition then (z, h) ← ⊥ |
| 15: | else |
| 16: | h ← MakeHint(input) |
| 17: | end if |
| 18: | end while |

Here, “a” is a polynomial expression, “r” is a parameter in which the row number is stored, and “s” is a parameter in which the column number is stored. The other symbols are the same as those in the pseudo code P1, and therefore, descriptions thereof are omitted.

The first line in the comparative example 1 corresponds to the seventh line and the eighth line in the comparative example 2. On the eighth line, the polynomial expression “a” (more specifically, coefficients of the polynomial expression “a”) that is an element of the matrix “A” is calculated from the seed “ρ″” (in which “ρ”, “s”, and “r” are joined), by “RejNTTPoly”, which is a hash function, and the calculated polynomial expression “a” is held in the memory. The calculation of “RejNTTPoly” includes an absorption process of absorbing the seed “ρ′” in the internal state and a squeeze process of squeezing a hash value from the internal state.

On the ninth line, the held polynomial expression “a” is read from the memory, and the polynomial expression computation is executed. In the case where the polynomial expression “a” has 0-order to (n−1)-order coefficients and each coefficient is stored in a 32-bit (4-byte) variable, a memory size of n×32 bits (n×4 bytes) is necessary for holding the polynomial expression “a”. For example, in ML-DSA, because of n=256, a memory size of 1024 bytes is necessary for holding the polynomial expression “a”.

The second to eighteenth lines constitute a repetitive structure for the signature candidate generation. The fourth to eleventh lines correspond to the matrix computation. The third to thirteenth lines correspond to the generation of the signature candidate, and the fourteenth line corresponds to the determination of whether the predetermined condition relevant to the signature candidate is satisfied. In the case where the predetermined condition is satisfied, the generation (the third to thirteenth lines) of the signature candidate is repeated, and in the case where the predetermined condition is not satisfied, the vector “h” is calculated on the sixteenth line. Thereafter, the signature “(c, z, h)” is obtained using the vectors “z” and “h”, and the polynomial expression “c” that are calculated by the computation of the pseudo code P2.

The fifth line in the comparative example 1 corresponds to the ninth line in the comparative example 2. The vectors “y”, “z”, and “h” are also objects of the memory saving. However, here, descriptions will be made with a focus on the matrix “A”.

In the case where the streaming process is performed as shown in the pseudo code P2, the process (the calculation and holding of the polynomial expression “a”) on the eighth line and the process (computation) on the ninth line are repeatedly executed in the interior of the repetitive structure for the signature candidate generation, to the number of combinations of “r” and “s”. Whenever the process (the calculation and holding of the polynomial expression “a”) on the eighth line is performed, the polynomial expression “a” in the memory is overwritten (updated).

More specifically, the polynomial expression “a” is held in the memory using 1024 bytes, while the repetitive process in the signature generation process is executed. The held polynomial expression “a” is updated in the process on the eighth line each time, during the above repetitive process. Since the matrix “A” has 57344 bytes, it is found that the memory size necessary for the signature generation process is smaller compared to the comparative example 1 (the case where the streaming process is not performed).

Meanwhile, the first line (the calculation of the matrix “A”) in the comparative example 1 only needs to be executed in the exterior of the repetitive structure for the signature candidate generation, just one time. On the other hand, in the comparative example 2, the matrix computation (the fourth to eleventh lines) is executed in the interior of the repetitive structure for the signature candidate generation, to the number of repetitions (that is, whenever it is determined on the fourteenth line that the predetermined condition is satisfied). In other words, the calculation of the polynomial expression “a” (the seventh and eighth lines) that is performed for each combination of “r” and “s” is repeatedly performed to the number of repetitions. Therefore, an execution cycle count overhead in the comparative example 2 is larger compared to the comparative example 1 (the case where the streaming process is not performed).

The above-described pseudo code P2 is an exemplary streaming process of holding coefficients in units of the polynomial expression “a” that is a matrix element, and similarly, streaming processes of holding coefficients in units of a row or column of the matrix “A” and in units of a coefficient of the polynomial expression “a” that is a matrix element can be adopted. Examples of the memory size that is necessary in these cases will be described below.

(Case where Coefficients of Polynomial Expression are Held in Units Of Row (Case where Row Vector is Held))

In the case where the row vector has a l-dimension, the polynomial expression has 0-order to (n−1)-order coefficients, and each coefficient is stored in a 32-bit (4-byte) variable, a memory size of l×n×32 bits (l×n×4 bytes) is necessary for holding the row vector. For example, in security category 5 for ML-DSA, because of l=7 and n=256, a memory size of 7168 bytes is necessary for holding the row vector.

(Case where Coefficients of Polynomial Expression are Held in Units of Column (Case where Column Vector is Held))

In the case where the column vector has a k-dimension, the polynomial expression has 0-order to (n−1)-order coefficients, and each coefficient is stored in a 32-bit (4-byte) variable, a memory size of k×n×32 bits (k×n×4 bytes) is necessary for holding the column vector. For example, in security category 5 for ML-DSA, because of k=8 and n=256, 8192 bytes are necessary for holding the column vector.

(Case where Coefficients of Polynomial Expression are Held in Units of Coefficient)

In the case where each coefficient of the polynomial expression “a” is stored in a 32-bit (4-byte) variable, a memory size of 32 bits (4 bytes) is necessary for holding the coefficient.

Thus, it is found that the memory size necessary for the signature generation process in the comparative example 2 may be a memory size for holding a part of the matrix “A” instead of the whole of the matrix “A” because of the streaming process and therefore may be smaller compared to the comparative example 1 (the case where the streaming process is not performed).

Meanwhile, in the comparative example 1, the process of calculating, from the seed, the coefficients of the polynomial expression that is the element of the matrix is executed in the exterior of the repetitive structure for the signature candidate generation, just one time. On the other hand, in the comparative example 2, the process of calculating, from the seed, the coefficients of the polynomial expression that is the element of the matrix is executed to the number of repetitions (that is, whenever it is determined on the fourteenth line that the predetermined condition is satisfied). Therefore, the overhead of the execution cycle count in the comparative example 2 is larger compared to the comparative example 1.

The embodiments make it possible to restrain at least one of the memory size and the overhead of the execution cycle count, compared to the above-described comparative example 1 and comparative example 2. Details will be described below.

### Embodiment 1

An embodiment 1 makes it possible to select, for each element of the matrix, whether the process of calculating the coefficients of the polynomial expression is executed in the exterior of the repetitive structure for the signature candidate generation just one time or is executed in the interior of the repetitive structure for the signature candidate generation to the number of repetitions (whether the streaming process is performed). Which of them is selected may be previously designated for each element of the matrix, or may be designated as a parameter by a user. In this way, in the embodiment 1, for some elements, the streaming process is performed similarly to the comparative example 2, and for the other elements, the process is executed in the exterior of the repetitive structure just one time similarly to the comparative example 1 (referred to as a non-streaming process). Such a process in the embodiment is referred to as a hybrid process of the streaming process and the non-streaming process. Thereby, it is possible to restrain at least one of the memory size necessary for the signature generation process and the execution cycle count overhead.

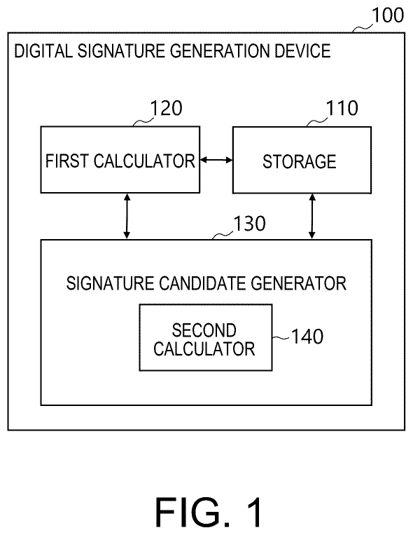

FIG. 1 is a functional block diagram of a digital signature generation device 100 as an information processing device according to the embodiment. The digital signature generation device 100 includes a storage 110, a first calculator 120, and a signature candidate generator 130. The signature candidate generator 130 includes a second calculator 140.

The storage 110 stores information necessary for processes in the embodiment and information generated by processes in the embodiment. For example, the information necessary for processes in the embodiment can include a private key, codes (programs) of an algorithm relevant to a process according to the embodiment, parameters that are used in programs, and the like. The information generated by processes in the embodiment includes information (various vectors, polynomial expressions, signature candidates, and the like) generated in the middle of computation, and a digital signature that is finally generated as output information.

The storage 110 includes a memory. The memory may be a volatile memory, or may be a non-volatile memory. The storage 110 is not limited to the memory, and may be a storage device such as an SSD (Solid State Drive). The storage 110 may be a network storage.

The first calculator 120, the signature candidate generator 130, and the second calculator 140 constitute a processor that performs the process according to the embodiment.

The first calculator 120 reads a private key from the storage 110, and calculates a seed. A seed previously calculated from the private key may be stored in the storage 110, and the seed may be read. The first calculator 120 calculates polynomial expressions from the seed, for X elements of a plurality of elements in the matrix. The polynomial expression calculated for each of the X elements is referred to as a first polynomial expression. The first calculator 120 writes the first polynomial expression calculated for each element, in the storage 110. More specifically, each coefficient of the first polynomial expression is written. The storage 110 stores the first polynomial expression calculated by the first calculator 120. Since the first polynomial expression is generated for each of the X elements, X first polynomial expressions are stored in the storage 110. The storage 110 includes a first storage that stores the first polynomial expression.

The second calculator 140 calculates a polynomial expression from the above seed, for an element designated from the signature candidate generator 130. The polynomial expression calculated by the second calculator 140 is referred to as a second polynomial expression. The second calculator 140 writes the calculated second polynomial expression in the storage 110. More specifically, each coefficient of the second polynomial expression is written. The storage 110 stores the second polynomial expression calculated by the second calculator 140. When the second calculator 140 writes the second polynomial expression in the storage 110, the second calculator 140 overwrites the second polynomial expression written in the storage 110 for the last time. Thereby, for the storage of the second polynomial expression, it is only necessary to have at least a memory size equivalent to one second polynomial expression. However, a memory size equivalent to two polynomial expressions may be prepared, and overwriting may be alternately performed, for example. The storage 110 includes a second storage that stores the second polynomial expression.

The signature candidate generator 130 sequentially selects the plurality of elements in the matrix. When the selected element is one of the X elements, the signature candidate generator 130 reads a polynomial expression (the first polynomial expression) corresponding to the selected element, from the storage 110, and performs computation based on the first polynomial expression. When the selected element is one of Y elements other than the above X elements, the signature candidate generator 130 calculates a polynomial expression (the second polynomial expression) for the selected element and writes the polynomial expression in the storage 110, using the second calculator 140. The signature candidate generator 130 reads the polynomial expression calculated by the second calculator 140 for the selected element, from the storage 110, and performs computation based on the read second polynomial expression. The series of operations is repeated for the plurality of elements in the matrix, and thereby, a signature candidate is generated.

The signature candidate generator 130 determines whether a predetermined condition is satisfied for the generated signature candidate. When the predetermined condition is satisfied, the signature candidate generator 130 performs the generation of the signature candidate by repeating the above series of operations again, for the plurality of elements in the matrix. The signature candidate generator 130 repeats the generation of the signature candidate until it is determined that the predetermined condition is not satisfied. In the computation based on the above polynomial expression (the first polynomial expression and the second polynomial expression) that is performed in each repetition, a parameter (the counter value “κ” in this example) that changes for each repetition is used. Thereby, a different signature candidate can be generated for each repetition.

When it is determined that the predetermined condition is not satisfied, the signature candidate generator 130 acquires a digital signature based on a signature candidate at that time and a signature function.

An example of a pseudo code showing an algorithm relevant to a process according to the embodiment 1 is shown below as a pseudo code E1.

(Pseudo Code E1)

| | |
|---|---|
| 01: | while (r, s) in List do |
| 02: | ρ′ ← ρ∥s∥r |
| 03: | A′[Pack(r, s)] ← RejNTTPoly(ρ′) |
| 04: | end do |
| 05: | (z, h) ← ⊥ |
| 06: | while (z, h) = ⊥ do |
| 07: | y ← ExpandMask(ρ″, κ) |
| 08: | for r from 0 to k−1 do |
| 09: | w[r] ← 0 |
| 10: | for s from 0 to l−1 do |
| 11: | if (r, s) in List then a ← A′[Pack(r, s)] |
| 12: | else |
| 13: | ρ′ ← ρ∥s∥r |
| 14: | a ← RejNTTPoly(ρ′) |
| 15: | end if |
| 16: | w[r] ← w[r] + a y[s] |
| 17: | end for |
| 18: | end for |
| 19: | c ← H(μ∥HighBits(w)) |
| 20: | z ← y + c s1 |
| 21: | if predetermined condition then (z, h) ← ⊥ |
| 22: | else |
| 23: | h ← MakeHint(input) |
| 24: | end if |
| 25: | end while |

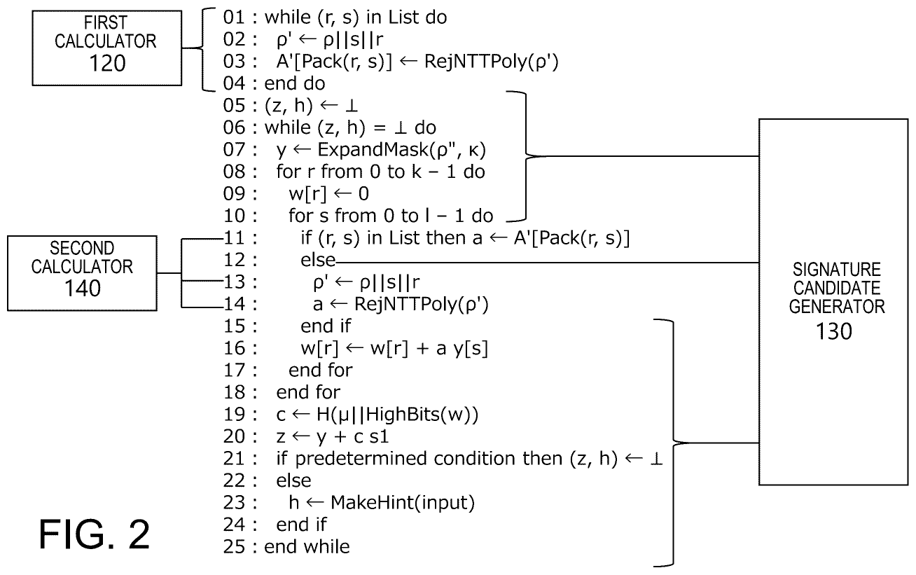

The process according to the pseudo code E1 is performed by the first calculator 120, the signature candidate generator 130, and the second calculator 140. FIG. 2 shows the correspondence relation between processes to be performed by these units and codes in the pseudo code E1. The first calculator 120 performs processes on the first to fourth lines, the second calculator 140 performs processes on the eleventh line, the thirteenth line, and the fourteenth line, and the signature candidate generator 130 performs processes on the fifth to tenth lines, the twelfth line, and the fifteenth to 25th lines. This correspondence relation is an example, and another correspondence relation also can be adopted. In the case where the first calculator 120, the signature candidate generator 130, and the second calculator 140 are implemented with a CPU, performing the process according to the pseudo code E1 by the first calculator 120, the signature candidate generator 130, and the second calculator 140 is equivalent to performing each process on the lines in the pseudo code E1 by the CPU.

The second line and the third line in the embodiment 1 correspond to the first line in the comparative example 1. The thirteenth line and the fourteenth line in the embodiment 1 correspond to the seventh line and the eighth line in the comparative example 2. Further, the sixteenth line in the embodiment 1 corresponds to the fifth line in the comparative example 1 and the ninth line in the comparative example 2.

The 6th to 25th lines constitute a repetitive structure for the signature candidate generation. The 7th to 20th lines correspond to the generation of the signature candidate. The 8th to 18th lines correspond to the matrix computation. The 21st line corresponds to the determination of whether the predetermined condition is satisfied. The pseudo code E1 will be described below in more detail.

“List” on the first line is a list for specifying elements (the above-described X elements) in the matrix “A” for which the non-streaming process is performed. For example, information indicating elements previously selected or elements designated by the user is stored in the list. The list is stored in the storage 110. The matrix “A” is a k-by-I matrix.

The elements specified by “List” may be shown by a range of consecutive elements from the beginning, as exemplified by a range from row 0, column 0 to row k′ (≤k), column l′ (≤l), or may be shown by a k′-by-l′ matrix “A″” that is an arbitrary part of the k-by-I matrix “A”. Alternatively, the elements specified by “List” may be a set of inconsecutive elements, or may be a set of random elements.

“Pack” on the third line is a function for designating a method for storing the elements specified by “List”.

The first calculator 120 calculates polynomial expressions (the first polynomial expression) for the X elements that are of the plurality of elements in the matrix “A” and that are specified by “List”, using a seed and row numbers and column numbers of the elements, as a process corresponding to the first to fourth lines in the pseudo code E1. Specifically, by joining the seed “ρ” and the row number and column number of the element, a new seed “ρ″” is made, and a polynomial expression is calculated by adopting the seed “ρ′” as an input of “RejNTTPoly”. The calculation of “RejNTTPoly” includes an absorption process of absorbing the seed “ρ′” in the internal state and a squeeze process of squeezing a hash value from the internal state. A set (referred to as a set “A″”) of X polynomial expressions calculated for the X elements is held in the storage 110. More specifically, a plurality of (n) coefficients included in each of the X polynomial expressions is held in the storage 110.

In the case where a polynomial expression (referred to as a polynomial expression “a”) has 0-order to (n−1)-order coefficients (a₀, a₁, a₂, . . . , aₙ₋₁) as shown in the following expression (1), (a₀, a₁, a₂, . . . , aₙ₋₁) are held for each of the X elements. In the following expression, “x” is a lowercase character, and is different from “X” that is an uppercase character showing the number of elements.

$$a = {a}_{0} + {a}_{1} {x}^{1} + {a}_{2} {x}^{2} + … + {a}_{n - 1} {x}^{n - 1} \qquad ( 1 )$$

In the case where the coefficient is stored in a 32-bit (4-byte) variable, X×n×32 bits (X×n×4 bytes) are necessary for holding the polynomial expressions for the X elements. For example, in ML-DSA, because of n=256, in the case of X=11, 11264 bytes are necessary for holding the polynomial expressions for the set of elements “A′”.

The second calculator 140 calculates polynomial expressions (the second polynomial expression) from the above seed, for elements that is of the plurality of elements in the matrix “A” and that are not specified by “List”, that is, for Y elements that are of the plurality of elements in the matrix “A” and that are other than the above X elements, as a process corresponding to the eleventh line, the thirteenth line and the fourteenth line in the pseudo code E1. “RejNTTPoly” on the fourteenth line is a function that calculates the polynomial expression. The calculation of “RejNTTPoly” includes an absorption process of absorbing the seed “ρ′” in the internal state and a squeeze process of squeezing a hash value from the internal state. The second calculator 140 writes the calculated polynomial expression (the second polynomial expression) in the storage 110. More specifically, each coefficient included in the polynomial expression is held in the storage 110. At this time, the last polynomial expression (the second polynomial expression) stored in the storage 110 is updated. Thereby, the latest polynomial expression (the second polynomial expression) is held in the storage 110.

In the case where the polynomial expression “a” has 0-order to (n−1)-order coefficients and each coefficient is stored in a 32-bit (4-byte) variable, n×32 bits (n×4 bytes) are necessary for holding the polynomial expression “a”. For example, in ML-DSA, because of n=256, 1024 bytes are necessary for holding the polynomial expression “a”.

The signature candidate generator 130 performs computation (the sixteenth line) for each of the X polynomial expressions (the first polynomial expression) acquired in the process on the third line by the first calculator 120. Further, the signature candidate generator 130 performs computation (the sixteenth line) for each of the Y polynomial expressions (the second polynomial expression) that are sequentially acquired in the process on the fourteenth line by the second calculator 140. Thereafter, the signature candidate generator 130 performs computations on the 19th line and the 20th line, to generate signature candidates “c” and “z”. Whether the predetermined condition on the 21st line is satisfied for the generated signature candidates is determined. In the case where the predetermined condition is satisfied, the generation of the signature candidate is repeated (the 7th to 20th lines), using the second calculator 140. In the case where the predetermined condition is not satisfied, the vector “h” is calculated by the “MakeHint” function, as the process on the 23rd line.

Thereafter, the signature candidate generator 130 obtains the signature “(c, z, h)” using “c”, “z”, and “h”, as a process in the exterior of the pseudo code E1. More specifically, a bit string (byte string) showing a digital signature is obtained by inputting “c”, “z”, and “h” to an encode function.

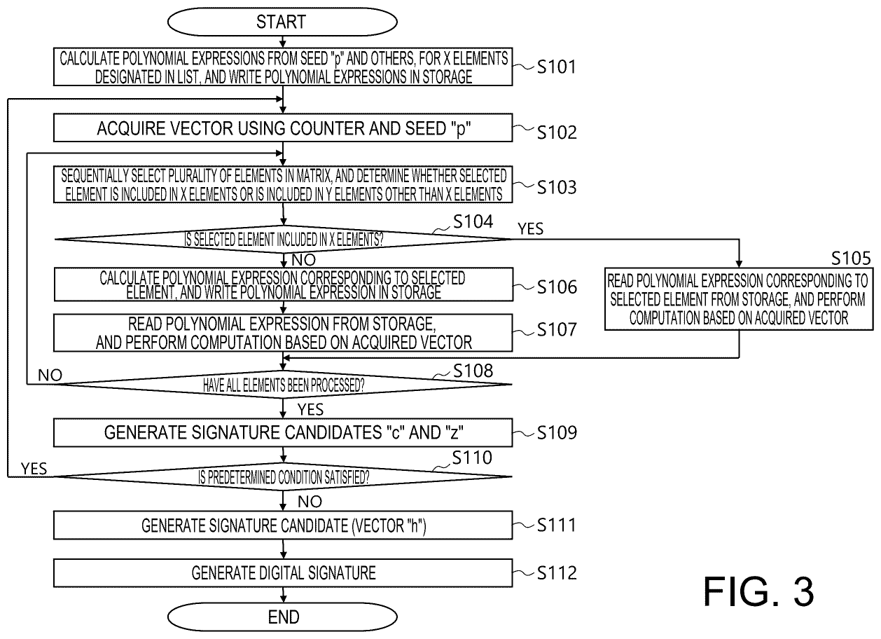

FIG. 3 is a flowchart showing an example of the operation of the digital signature generation device 100, as an information processing method according to the embodiment 1.

The first calculator 120 reads the list for designating the X elements of the plurality of elements in the matrix and the seed, from the storage 110, and calculates polynomial expressions (the first polynomial expression) for the X elements specified in the list, from the seed and the row numbers and column numbers of the elements (S101). The first calculator 120 writes the first polynomial expression calculated for each element, in the storage 110 (S101).

The signature candidate generator 130 acquires a vector (the vector “y”) using the counter value “κ” (a parameter that changes for each repetition) and the seed (the seed “ρ″”) (S102).

The signature candidate generator 130 sequentially selects the plurality of elements in the matrix, and determines whether the selected element is one of the X elements designated in the list (S103). In the case of one of the X elements (YES), the polynomial expression (the first polynomial expression) corresponding to the selected element is read from the storage 110, and the computation (the sixteenth line) is performed based on the first polynomial expression (S105).

In the case where the selected element is one of the remaining Y elements other than the above X elements (NO), the signature candidate generator 130 calculates the polynomial expression (the second polynomial expression) for the selected element and stores the polynomial expression in the storage 110, using the second calculator 140 (S106). That is, the signature candidate generator 130 causes the second calculator 140 to calculate the second polynomial expression for the selected element and store the calculated second polynomial expression in the storage 110. The signature candidate generator 130 reads the second polynomial expression calculated by the second calculator 140, from the storage 110, and performs the computation (the sixteenth line) based on the second polynomial expression.

Whether the processes in steps S103 to S107 have been performed for all of the plurality of elements in the matrix is determined (S108), and in the case where there is an element for which the processes have not been performed yet, the operation returns to step S103. In the case where the processes have been performed for all elements, the signature candidates “c” and “z” are generated based on the result of the computation for each element (S109), and whether the predetermined condition is satisfied for the generated signature candidates is determined (S110). In the case where the predetermined condition is satisfied (YES), the operation returns to step S102, and the signature generation is performed again. On this occasion, the counter value is incremented. In the case where the predetermined condition is not satisfied (NO), the signature candidate (the vector “h”) is calculated by the “MakeHint” function (S111). Then, the digital signature is acquired by inputting the signature candidates “c”, “z”, and “h” to the encode function (S112).

### Effect of Embodiment 1

In the embodiment 1, for the X specified elements, the process on the third line is executed in the exterior of the repetitive structure for the signature candidate generation, just one time, and thereby, the respective corresponding polynomial expressions are calculated and held. On the other hand, for the Y elements other than the above X elements, the process on the fourteenth line is executed in the interior of the repetitive structure for the signature candidate generation, to the number of repetitions, and for each execution, the corresponding polynomial expression “a” is calculated and held (updated).

Accordingly, while the repetitive process for the signature candidate generation is executed, the set “A” of the polynomial expressions (the first polynomial expression) corresponding to the X specified elements is held in the storage 110 with use of a memory size of 11264 bytes, and the polynomial expression “a” (the second polynomial expression) is repeatedly updated and held in the storage 110 with use of a memory size of 1024 bytes. Since the matrix “A” has 57344 bytes, it is found that the memory size necessary for the signature generation process in the embodiment 1 is smaller compared to the comparative example 1 (the case where the streaming process is not performed) and is larger compared to the comparative example 2 (the case where the streaming process is performed).

Further, the process on the third line in the embodiment 1 is executed in the exterior of the repetitive structure for the signature candidate generation, just one time, and the processes on the thirteenth and fourteenth lines are executed in the interior of the repetitive structure for the signature candidate generation, to the number of repetitions. On the other hand, the first line in the comparative example 1 is executed in the exterior of the repetitive structure for the signature candidate generation, just one time, and the seventh and eighth lines in the comparative example 2 are executed in the interior of the repetitive structure for the signature candidate generation, to the number of repetitions. Therefore, the execution cycle count overhead in the embodiment 1 is larger compared to the comparative example 1 (the case where the streaming process is not performed) and is smaller compared to the comparative example 2 (the case where the streaming process is performed).

### Embodiment 2

In the embodiment 2, in the exterior of the repetitive structure for the signature candidate generation, for the plurality of elements in the matrix, intermediate values are calculated from the seed, and the calculated intermediate values are held in the storage 110. In the interior of the repetitive structure for the signature candidate generation, for the plurality of elements in the matrix, the calculation of the polynomial expression from the intermediate value is executed to the number of repetitions (streaming process). Thereby, the memory size necessary for the signature generation process and the execution cycle count overhead for the signature generation process are restrained.

A block diagram in the embodiment is the same as that in the embodiment 1, and is shown in FIG. 1. However, a part of the function of each block is altered or enhanced.

The first calculator 120 reads the seed calculated from the private key, from the storage 110, and calculates the intermediate value from the seed for each of the plurality of elements in the matrix. For the calculation of the intermediate value, the row number and column number of the element are used in addition to the seed. The intermediate value corresponds to a value that is obtained in the middle of the calculation of the polynomial expression from the seed. In the embodiment, as described later, by calculating the polynomial expression from the intermediate value in the interior of the repetitive structure for the signature candidate generation, it is possible to reduce the execution cycle count overhead compared to the case where the polynomial expression is calculated from the seed.

The first calculator 120 writes the intermediate value calculated for each element in the matrix, in the storage 110. The storage 110 stores the intermediate value calculated by the first calculator 120. Since the intermediate value is generated for each of the plurality of elements, the same number of intermediate values as the number of elements in the matrix are stored in the storage 110.

The second calculator 140 calculates the polynomial expression from the intermediate value, for elements that are of the plurality of elements in the matrix and that are designated by the signature candidate generator 130. Whenever the second calculator 140 calculates the polynomial expression, the second calculator 140 writes the calculated polynomial expression in the storage 110. More specifically, each coefficient of the polynomial expression is written in the storage 110. The storage 110 stores the polynomial expression calculated by the second calculator 140. When the second calculator 140 writes the polynomial expression in the storage 110, the second calculator 140 overwrites the polynomial expression written in the storage 110 for the last time. Accordingly, for the storage of the polynomial expression, it is only necessary to have a memory size equivalent to one polynomial expression. However, a memory size equivalent to two polynomial expressions may be prepared, and overwriting may be alternately performed, for example.

The signature candidate generator 130 sequentially selects the plurality of elements in the matrix, and calculates the polynomial expression for the selected element, from the intermediate value read from the storage 110, using the second calculator 140. That is, the signature candidate generator 130 causes the second calculator 140 to calculate the polynomial expression for the selected element and store the calculated polynomial expression in the storage 110. The signature candidate generator 130 reads the polynomial expression from the storage 110, and executes computation based on the read polynomial expression. The signature candidate generator 130 repeats the series of operations for all of the plurality of elements in the matrix, and thereby, generates the signature candidate.

The signature candidate generator 130 determines whether the predetermined condition is satisfied for the generated signature candidate. When the predetermined condition is satisfied, the signature candidate generator 130 performs the generation of the signature candidate by repeating the above series of operations for the plurality of elements in the matrix again, using the second calculator 140. The signature candidate generator 130 repeats the generation of the signature candidate until it is determined that the predetermined condition is not satisfied. In the computation based on the above polynomial expression that is performed in each repetition, a parameter (a counter value in this example) that changes for each repetition is used. Thereby, a different signature candidate can be generated for each repetition.

An example of a pseudo code showing an algorithm relevant to a process according to the embodiment 2 is shown below as a pseudo code E2.

(Pseudo Code E2)

| 01: | for r from 0 to k−1 do |
|---|---|
| 02: | for s from 0 to l−1 do |
| 03: | ρ′ ← ρ∥s∥r |
| 04: | ctx[r, s] ← G.Init( ) |
| 05: | ctx[r, s] ← G.Absorb(ctx[r, s], ρ′) |
| 06: | end for |
| 07: | end for |
| 08: | (z, h) ← ⊥ |
| 09: | while (z, h) = ⊥ do |
| 10: | y ← ExpandMask(ρ″, κ) |
| 11: | for r from 0 to k−1 do |
| 12: | w[r] ← 0 |
| 13: | for s from 0 to l−1 do |
| 14: | j ← 0 |
| 15: | ctx′ ←ctx[r, s] |
| 15: | while j < n do |
| 16: | (ctx′, s′) ← G.Squeeze(ctx′, 3) |
| 17: | a[j] ← CoeffFromThreeBytes(s′[0], s′[1], |
| s′[2]) | |
| 18: | if a[j] ≠ ⊥ then |
| 19: | j ← j + 1 |
| 20: | end if |
| 21: | end while |
| 22: | w[r] ← w[r] + a y[s] |
| 23: | end for |
| 24: | end for |
| 25: | c ← H(μ∥HighBits(w)) |
| 26: | z ← y + c s1 |
| 27: | if predetermined condition then (z, h) ← ⊥ |
| 28: | else |
| 29: | h ← MakeHint(input) |
| 30: | end if |
| 31: | end while |

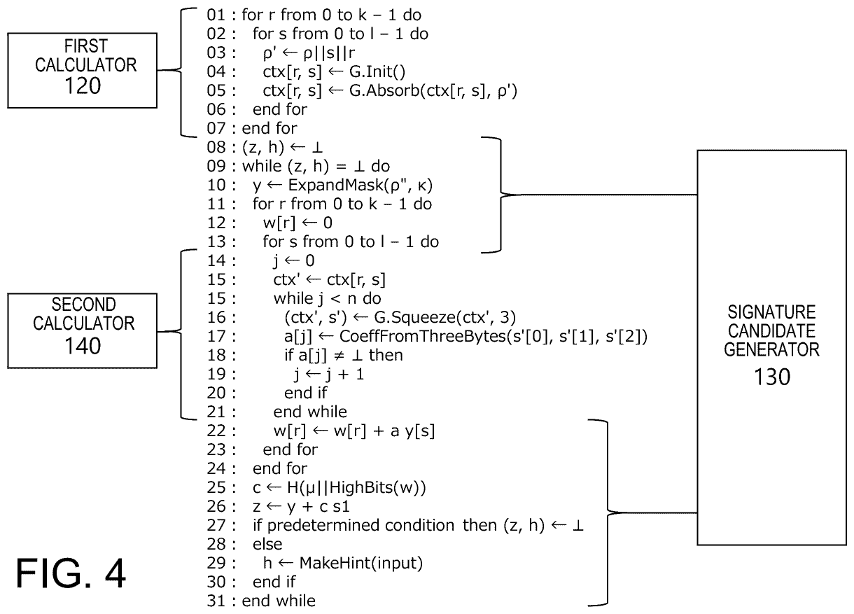

The first calculator 120, the signature candidate generator 130, and the second calculator 140 performs the process according to the pseudo code E2. FIG. 4 shows the correspondence relation between processes to be performed by these units and codes in the pseudo code E2. The first calculator 120 performs processes on the first to 7th lines, the second calculator 140 performs processes on the 14th to 21st lines, and the signature candidate generator 130 performs processes on the 8th to 13th lines and the 22nd to 31st lines. In the case where the first calculator 120, the signature candidate generator 130, and the second calculator 140 are implemented with a CPU, performing the process according to the pseudo code E2 by the first calculator 120, the signature candidate generator 130, and the second calculator 140 is equivalent to performing each process on the lines in the pseudo code E2 by the CPU.

The 3rd to 5th lines in the embodiment 2 correspond to the 1st line in the comparative example 1, and the 14th to 21st lines in the embodiment 2 correspond to the 7th line and the 8th line in the comparative example 2. The 22nd line in the embodiment 2 corresponds to the 5th line in the comparative example 1 and the 9th line in the comparative example 2.

The 9th to 31st lines constitute a repetitive structure for the signature candidate generation. The 10th to 26th lines correspond to the generation of the signature candidate. The 11th to 24th lines correspond to the matrix computation. The 27th line corresponds to the determination of whether the predetermined condition is satisfied.

A function “G” shows an extensible output hash function, a function “G. Init” shows an initialization process therefor, a function “G.Absorb” shows an absorption process therefor, and a function “G.Squeeze” shows a squeeze process therefor. For implementation, borders of processes may be intendedly altered, may be partially divided, or may be partially merged.

The first calculator 120, by “G.Absorb”, calculates an intermediate value “ctx” and holds the intermediate value “ctx” in the storage 110, for each element in the k-by-I matrix “A”, in the exterior of the repetitive structure for the signature candidate generation, as a process corresponding to the fifth line. That is, for each combination of the row “r” and the column “s”, the intermediate value “ctx” is calculated, and the intermediate value “ctx” is held. In the case where the intermediate value “ctx” is stored in a 5×5 array of 64 bits (8 bytes), k×l×64×25 bits (k×l×8×25 bytes) are necessary for the holding. For example, in security category 5 for ML-DSA, because of k=8 and l=7, a memory size of 11200 bytes is necessary for holding intermediate values corresponding to all elements.

The second calculator 140 reads the intermediate value from the storage 110 and calculates the polynomial expression “a” from the intermediate value, for each element in the matrix “A”, as a process corresponding to the fourteenth to 21st lines. The second calculator 140 writes the calculated polynomial expression “a” in the storage 110. More specifically, each coefficient included in the polynomial expression “a” is held in the storage 110. At this time, the last polynomial expression “a” stored in the storage 110 is updated. Thereby, the latest calculated polynomial expression “a” is held in the storage 110. The storage 110 includes a memory region (a first storage) for the intermediate value and a memory region (a second storage) for the polynomial expression.

In the case where the polynomial expression “a” has 0-order to (n−1)-order coefficients and each coefficient is stored in a 32-bit (4-byte) variable on the seventeenth line, a memory size of n×32 bits (n×4 bytes) is necessary for holding the polynomial expression “a”. For example, in ML-DSA, because of n=256, a memory size of 1024 bytes is necessary for holding the polynomial expression “a”.

The signature candidate generator 130 performs computation based on the polynomial expression acquired by the second calculator 140, as the process on the 22nd line. That is, the polynomial expression “a” is read from the storage 110, and computation is executed. After the computation of the polynomial expression is performed for all elements, the signature candidate generator 130 performs computations on the 25th line and the 26th line, to generate signature candidates “c” and “z”. The signature candidate generator 130 determines whether the predetermined condition is satisfied for the generated signature candidate, as the process on the 27th line. In the case where the predetermined condition is satisfied, the generation of the signature candidate is repeated using the second calculator 140 (the tenth to 26th lines). In the case where the predetermined condition is not satisfied, the vector “h” is calculated by the “MakeHint” function, as the process on the 29th line.

Thereafter, the signature candidate generator 130 obtains the signature “(c, z, h)” using “c”, “z”, and “h”, as a process in the exterior of the pseudo code E2. More specifically, a bit string (byte string) showing a digital signature is obtained by inputting “c”, “z”, and “h” to an encode function.

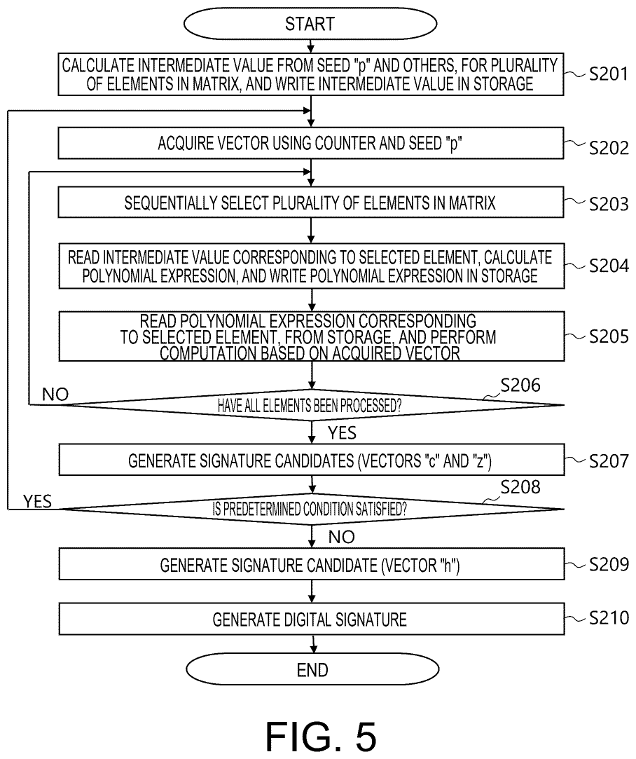

FIG. 5 is a flowchart showing an example of the operation of the digital signature generation device 100 as an information processing method according to the embodiment 2.

The first calculator 120 reads the seed calculated from the private key, from the storage 110, and calculates the intermediate value for each of the plurality of elements in the matrix, from the seed and the row number and column number of the element (S201). The first calculator 120 writes the intermediate value calculated for each element, in the storage 110 (S201).

The signature candidate generator 130 acquires a vector (the vector “y”) using the counter value “κ” (a parameter that changes for each repetition) and the seed (the seed “ρ″”) (S202).

The signature candidate generator 130 sequentially selects the plurality of elements in the matrix (S203), reads the intermediate value for the selected element, from the storage 110, and calculates the polynomial expression from the read intermediate value using the second calculator 140 (S204). The second calculator 140 stores the calculated polynomial expression in the storage 110. The signature candidate generator 130 reads the polynomial expression for the element, and performs the computation (the sixteenth line) (S205).

The signature candidate generator 130 determines whether the processes in steps S203 to S205 have been performed for all of the plurality of elements in the matrix (S206). In the case where there is an element for which the processes have not been performed yet, the operation returns to step S203. In the case where the processes have been performed for all elements (YES), the signature candidates “c” and “z” are generated based on the result of the computation for each element (S207), and whether the predetermined condition is satisfied for the generated signature candidates is determined (S208). In the case where the predetermined condition is satisfied (YES), the operation returns to step S202, and the signature generation is performed again. On this occasion, the counter value is incremented. In the case where the predetermined condition is not satisfied (NO), the signature candidate (the vector “h”) is calculated by the “MakeHint” function (S209). Then, the digital signature is acquired by inputting the signature candidates “c”, “z”, and “h” to the encode function (S210).

### Effect of Embodiment 2

While the repetitive process for the signature candidate generation is executed, the intermediate value “ctx” is held in the storage 110 for all elements in the matrix, with use of a memory size of 11200 bytes, for example, and the polynomial expression “a” is repeatedly updated and held in the storage 110, with use of a memory size of 1024 bytes, for example. Since the matrix “A” has 57344 bytes as a whole, the memory size necessary for the signature generation process in the embodiment 2 is smaller compared to the comparative example 1, and is larger compared to the comparative example 2.

Further, in the comparative example 1, the first line (which is a process of calculating the matrix “A” and includes the absorption process and squeeze process for the hash function) in the pseudo code P1 is executed in the exterior of the repetitive structure for the signature candidate generation, just one time. In the comparative example 2, the eighth line (which is a process of calculating the polynomial expression “a” and includes the absorption process and squeeze process for the hash function) in the pseudo code P2 is executed in the interior of the repetitive structure for the signature candidate generation, to the number of repetitions (until the predetermined condition is not satisfied). On the other hand, in the embodiment 2, the fifth line (corresponding to the absorption process for the hash function) in the pseudo code E2 is executed in the exterior of the repetitive structure for the signature candidate generation, just one time, and the sixteenth line (corresponding to the squeeze process for the hash function) is executed in the interior of the repetitive structure for the signature candidate generation, to the number of repetitions (until the predetermined condition is not satisfied). Therefore, the execution cycle count overhead in the embodiment 2 is larger compared to the comparative example 1, and is smaller compared to the comparative example 2.

### Comparison Among Comparative Example 1, Comparative Example 2, Embodiment 1, and Embodiment 2

The number of repetitions (the number of repetitions until it is determined that the predetermined condition is not satisfied) in the repetitive structure for the signature candidate generation is referred to as “t”, and the memory size and execution cycle count overhead in the comparative example 1, the comparative example 2, the embodiment 1, and the embodiment 2 are arranged and shown in Table 1 as follows.

TABLE 1

| | Memory | |
|---|---|---|
| | Size | Execution Cycle Count Overhead |
| | (byte) | (times) |
| Comparative | k × l × | 0 |
| Example 1 | 1024 | |
| Comparative | 1024 | (absorption process + squeeze process) × |
| Example 2 | | k × l × (t − 1) |
| Embodiment 1 | X × 1024 + | (absorption process + squeeze process) × |
| | 1024 | (k × l − X) × (t − 1) |
| Embodiment 2 | k × l × | squeeze process × k × l × (t − 1) |
| | 200 + 1024 | |

In Table 1, as for the execution cycle count overhead, the execution cycle count (processing amount) in the comparative example 1 is adopted as a standard (═O), and a quantity by which the execution cycle count (processing amount) exceeds the standard is shown as the overhead. In this example, the number “n” of coefficients included in one polynomial expression is assumed to be n=256. Further, a memory size that is used in the repetitive structure is set to 1024 bytes, assuming that one polynomial expression (256 coefficients) is stored. However, the memory size that is used in the repetitive structure varies depending on the unit for the storage of the polynomial expression, and for example, is 4 bytes in the case where the polynomial expression is stored in units of a coefficient.

As seen from Table 1, the relation about the memory size is shown as follows.

$$Comparative Example 2 < Embodiment 1 < Comparative Example 1$$

$$Comparative Example 2 < Embodiment 2 < Comparative Example 1$$

Further, the relation about the execution cycle count overhead is shown as follows.

$$Comparative Example 1 < Embodiment 1 < Comparative Example 2$$

$$Comparative Example 1 < Embodiment 2 < Comparative Example 2$$

It is desirable that the memory size and the execution cycle count overhead are small, but there is no scheme by which both of the memory size and the execution cycle count overhead concurrently become smallest. The memory size and the execution cycle count overhead have a trade-off relation.

Which of the embodiment 1 and the embodiment 2 is more preferable depends on “k”, “l”, “X” (<k×l), the execution cycle count for the absorption process, and the execution cycle count for the squeeze process. For example, in the case of k=8, l=7, X=11, and (the execution cycle count for the squeeze process)< (the execution cycle count for the absorption process)×4, there is the same degree of memory size in the embodiment 1 and the embodiment 2, and the execution cycle count overhead is smaller in the embodiment 2 than in the embodiment 1. Therefore, the embodiment 2 is more preferable than the embodiment 1.

### Embodiment 3

In an embodiment 3, the embodiment 1 and the embodiment 2 are combined. A block diagram in the embodiment 3 is the same as that in the embodiment 1, and is shown in FIG. 1. However, some of the functions are altered or enhanced. More details are shown as follows.

The first calculator 120 executes the absorption process for the X elements, in the exterior of the repetitive structure for the signature candidate generation, just one time, to calculate intermediate values for the X elements, and holds the calculated X intermediate values in the storage 110. For holding the intermediate values, for example, a memory size of 200 bytes is used for each intermediate value.

The signature candidate generator 130 executes the calculation of the polynomial expression from the intermediate value for the X elements by the squeeze process, in the interior of the repetitive structure for the signature candidate generation, to the number of repetitions. For the calculation of the polynomial expression from the intermediate value, the signature candidate generator 130 uses the second calculator 140, similarly to the embodiment 2.

For the remaining Y elements, the signature candidate generator 130 executes the calculation (the absorption process+the squeeze process) of the polynomial expression from the seed and others, in the interior of the repetitive structure for the signature candidate generation, to the number of repetitions. For the calculation of the polynomial expression from the seed and others, the signature candidate generator 130 uses the second calculator 140, similarly to the embodiment 1. That is, in the embodiment 3, the second calculator 140 performs switching between the calculation (the squeeze process) of the polynomial expression from the intermediate value and the calculation (the absorption process+the squeeze process) of the polynomial expression from the seed and others, for each element. In the interior of the repetitive structure, the polynomial expression is held with use of a memory size equivalent to one polynomial expression.

A table in which the memory size and execution cycle count overhead in the embodiment 3 are added to Table 1 is shown below as Table 2.

TABLE 2

| | Memory | |
|---|---|---|
| | Size | Execution Cycle Count Overhead |
| | (byte) | (times) |
| Comparative | k × l × | 0 |
| Example 1 | 1024 | |
| Comparative | 1024 | (absorption process + squeeze process) × |
| Example 2 | | k × l × (t − 1) |
| Embodiment 1 | X × 1024 + | (absorption process + squeeze process) × |
| | 1024 | (k × l − X) × (t − 1) |
| Embodiment 2 | k × l × | squeeze process × k × l × (t − 1) |
| | 200 + 1024 | |
| Embodiment 3 | X × 200 + | (absorption process × (k × l − X) + |
| | 1024 | squeeze process × k × l) × (t − 1) |

In this case, the relation about the memory size is shown as follows.

$$Comparative Example 2 < Embodiment 3 < Embodiment 2$$

The relation about the execution cycle count overhead is shown as follows.

$$Embodiment 2 < Embodiment 3 < Comparative Example 2$$

Here, X<k×l is satisfied.

The embodiment 3 has a smaller memory size and a larger execution cycle count overhead than the embodiment 2.

Which of the embodiment 3 and the embodiment 1 is more preferable depends on “k”, “l”, “X” (“X” in the embodiment 1 and “X” in the embodiment 3 may be different from each other), the execution cycle count for the absorption process, and the execution cycle count for the squeeze process. For example, in the case of k=8, l=7, “X” in the embodiment 1=1, “X” in the embodiment 3=5, and (the execution cycle count for the squeeze process)< (the execution cycle count for the absorption process)×4, there is the same degree of memory size in the embodiment 1 and the embodiment 3. On the other hand, the execution cycle count overhead is smaller in the embodiment 3 than in the embodiment 1. Therefore, the embodiment 3 is more preferable than the embodiment 1.

### Embodiment 4

In an embodiment 4, the comparative example 1, the embodiment 1, and the embodiment 2 are combined. A block diagram in the embodiment 4 is the same as that in the embodiment 1, and is shown in FIG. 1. However, some of the functions are altered or enhanced.

More specifically, the first calculator 120 executes the absorption process for (X′+X) elements, in the exterior of the repetitive structure for the signature candidate generation, just one time, and executes the squeeze process for X′ elements, in the exterior of the repetitive structure for the signature candidate generation, just one time. Polynomial expressions for X′ elements and intermediate values for X elements are held in the storage 110.

The signature candidate generator 130 executes the absorption process for (k×l−X′−X) elements and the squeeze process for (k×l−X′) elements, in the interior of the repetitive structure for the signature candidate generation, to the number of repetitions. In the interior of the repetitive structure for the signature candidate generation, the polynomial expression is held with use of a memory size equivalent to one polynomial expression.

A table in which the memory size and execution cycle count overhead in the embodiment 4 are added to Table 2 is shown below as Table 3.

TABLE 3

| | Memory | |
|---|---|---|
| | Size | Execution Cycle Count Overhead |
| | (byte) | (times) |
| Comparative | k × l × | 0 |
| Example 1 | 1024 | |
| Comparative | 1024 | (absorption process + squeeze process) × |
| Example 2 | | k × l × (t − 1) |
| Embodiment | X × 1024 + | (absorption process + squeeze process) × |
| 1 | 1024 | (k × l − X) × (t − 1) |
| Embodiment | k × l × | squeeze process × k × l × (t − 1) |
| 2 | 200 + 1024 | |
| Embodiment | X × 200 + | (absorption process × (k × l − X) + |
| 3 | 1024 | squeeze process × k × l) × (t − 1) |
| Embodiment | X′ × 1024 × | (absorption process × (k × l − X′ − |
| 4 | X × 200 + | X) + squeeze process × (k × l − X′)) × |
| | 1024 | (t − 1) |

Compared to the embodiment 3, the memory size is larger, but the execution cycle count overhead can be restrained.

### Application Example

An application example in which each digital signature generation device 100 according to the above embodiments is used will be shown. The digital signature generation device 100 is equipped in each of a server and a certificate authority that authenticates a server certificate.

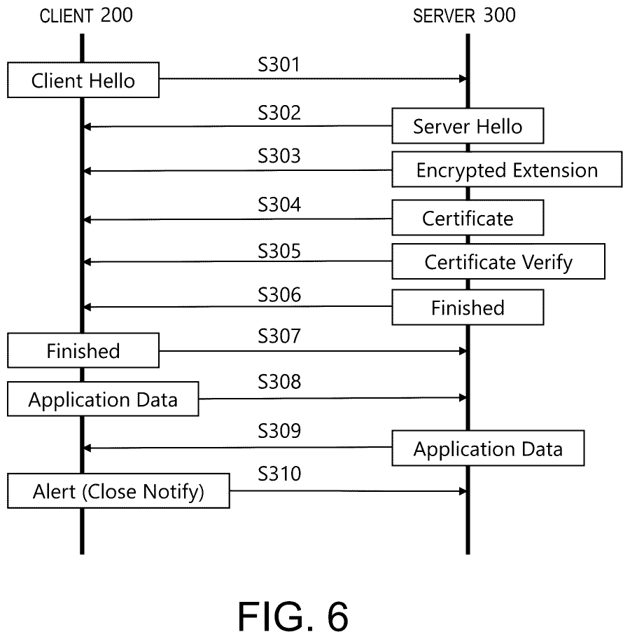

FIG. 6 shows an example of an operation sequence that is performed between a client 200 and a server 300. As an example, a handshake in TLS 1.3 is performed, and thereafter, a one-round-trip cryptographic data communication is performed.

For informing the start of a TLS communication to the server 300, the client 200 sends a Client Hello message (S301). In response to the Client Hello message, the server 300 sends a Server Hello message (S302). Thereby, a cipher suite and an encryption key that are used in the TLS communication are agreed between the client 200 and the server 300.

The server 300 encrypts information that is used in the TLS communication other than the cipher suite and the encryption key, and sends the information to the client 200 (S303). For example, a notice of a HTTPS version that is used in the TLS communication is given.

The server 300 sends a server certificate necessary for the authentication of the server 300, to the client 200 (S304). The server certificate includes a server public key for the server 300 and a digital signature that is previously generated for the server public key by the certificate authority using the digital signature generation device 100. This digital signature is generated by the signature generation process, using a private key for the certificate authority.

The server 300 generates a digital signature by executing the signature generation process to data for verification, using the digital signature generation device 100 and a server private key. The server 300 sends the generated digital signature and the data for verification, to the client 200 (S305). Thereafter, the server 300 sends a Finished message (S306).

The client 200 verifies the server certificate with the public key for the certificate authority, and verifies the data for verification that is received from the server 300, with server public key. Thereafter, the client 200 sends a Finished message (S307).

Thereafter, the client 200 sends encrypted application data (S308), the server 300 sends encrypted application data (S309), the client 200 sends an Alert (Close Notify) message to the server 300 (S310), and the process ends.

According to the application example, the certificate authority and the server 300 can rapidly generate the digital signatures with use of a small memory size, by using the digital signature generation devices 100 according to the embodiments. That is, it is possible to achieve the memory-saving implementation of the signature generation process and the restraint of the execution cycle count for the lattice-based digital signature.

(Hardware configuration)

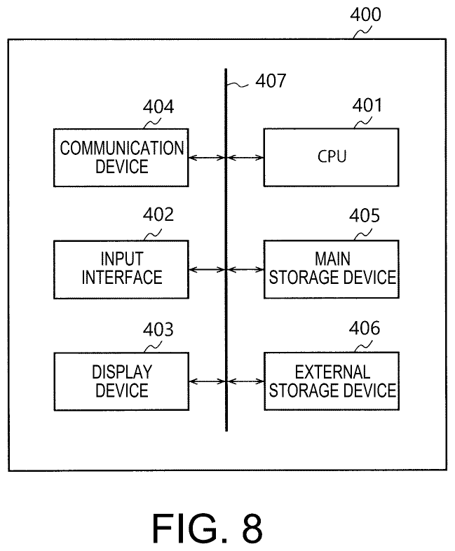

FIG. 8 illustrates a hardware configuration of the information processing apparatus 400 according to an embodiment. At least one of the digital signature generation device 100, the server 300, the client 200, and the certificate authority can be configured as information processing equipment 400 with the hardware configuration shown in FIG. 8. The information processing apparatus is configured as a computer device 400. The computer device 400 includes a CPU 401, an input interface 402, a display device 403, a communication device 404, a main storage device 405, and an external storage device 406, and these components are mutually connected through a bus 407.

The CPU (central processing unit) 401 executes an information processing program as a computer program on the main storage device 405. The information processing program is a computer program configured to achieve each above-described functional composition of the present device. The information processing program may be achieved by a combination of a plurality of computer programs and scripts instead of one computer program. Each functional composition is achieved as the CPU 401 executes the information processing program.

The input interface 402 is a circuit for inputting to the present information processing device, an operation signal from an input device such as a keyboard, a mouse, or a touch panel.

The display device 403 displays data output from the present device. The display device 403 is, for example, a liquid crystal display (LCD), an organic electroluminescence display, a cathode-ray tube (CRT), or a plasma display (PDP) but is not limited thereto. Data output from the computer device 400 can be displayed on the display device 403.

The communication device 404 is a circuit for the present device to communicate with an external device in a wireless or wired manner. Data can be input from the external device through the communication device 404. The data input from the external device can be stored in the main storage device 405 or the external storage device 406.

The main storage device 405 stores, for example, the information processing program, data necessary for execution of the information processing program, and data generated through execution of the information processing program. The information processing program is loaded and executed on the main storage device 405. The main storage device 405 is, for example, a RAM, a DRAM, or an SRAM but is not limited thereto. Each storage or database in the information processing apparatus in each embodiment may be implemented on the main storage device 405.

The external storage device 406 stores, for example, the information processing program, data necessary for execution of the information processing program, and data generated through execution of the information processing program. The information processing program and the data are read onto the main storage device 405 at execution of the information processing program. The external storage device 406 is, for example, a hard disk, an optical disk, a flash memory, or a magnetic tape but is not limited thereto. Each storage or database in the information processing apparatus in each embodiment may be implemented on the external storage device 406.

The information processing program may be installed on the computer device 400 in advance or may be stored in a storage medium such as a CD-ROM. Moreover, the information processing program in each embodiment may be uploaded on the Internet.

The information processing apparatus may be configured as a single computer device 400 or may be configured as a system including a plurality of mutually connected computer devices 400.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments of the present invention can also be configured as follows.

### CLAUSES

Clause 1. An information processing device comprising:
   a first calculator configured to calculate first polynomial expressions from a seed, for X elements of a plurality of elements in a matrix;
   a first storage configured to store the first polynomial expressions calculated by the first calculator; and
   a signature candidate generator configured to
      sequentially select the plurality of elements and
      when the selected element is one of the X elements, read the corresponding first polynomial expression from the first storage and perform computation based on the first polynomial expression; and
      when the selected element is one of Y elements other than the X elements, calculate a second polynomial expression for the selected element from the seed and perform computation based on the second polynomial expression,
   wherein the signature candidate is generated based on the result of the computation.
Clause 2. The information processing device according to claim 1, comprising a second calculator configured to calculate a second polynomial expression from the seed, for a designated element of the plurality of elements, wherein
   the signature candidate generator designates the selected element when the selected element is one of the Y elements, and
   the second calculator calculates the second polynomial expression for the selected element.
Clause 3. The information processing device according to claim 1, wherein
   the signature candidate generator determines whether a predetermined condition relevant to the signature candidate is satisfied, and repeats the generation of the signature candidate again when the predetermined condition is satisfied.
Clause 4. The information processing device according to claim 2, further comprising a second storage configured to store the second polynomial expression calculated by the second calculator, wherein
   the second calculator writes the second polynomial expression in the second storage whenever the second calculator calculates the second polynomial expression, and
   the signature candidate generator acquires the second polynomial expression by reading the second polynomial expression from the second storage.
Clause 5. The information processing device according to claim 4, wherein
   when the second calculator writes the second polynomial expression in the second storage, the second calculator overwrites the previously written second polynomial expression in the second storage.
Clause 6. The information processing device according to claim 3, wherein
   the first calculator calculates the seed from a private key,
   the signature candidate generator performs a process based on data that is a signature object, in the computation based on the first polynomial expression and in the computation based on the second polynomial expression, and
   the signature candidate generator generates a digital signature based on the signature candidate for which it is determined that the predetermined condition is not satisfied.
Clause 7. An information processing device comprising:
   a first calculator configured to calculate intermediate values from a seed, for a plurality of elements in a matrix;
   a first storage configure to store the plurality of intermediate values calculated by the first calculator; and
   a signature candidate generator configured to sequentially select the plurality of elements, and to generate a signature candidate by calculating a polynomial expression from the intermediate value read from the first storage for the selected element and executing computation based on the polynomial expression.
Clause 8. The information processing device according to claim 7, further comprising:
   a second calculator configured to calculate a polynomial expression from the intermediate value, for the selected element; and
   a second storage configured to store the polynomial expression calculated by the second calculator, wherein
   the second calculator writes the polynomial expression in the second storage, whenever the second calculator calculates the polynomial expression, and
   the signature candidate generator acquires the polynomial expression by reading the polynomial expression from the second storage.
Clause 9. The information processing device according to claim 7, wherein
   the signature candidate generator determines whether a predetermined condition relevant to the signature candidate is satisfied, and repeats the generation of the signature candidate again when the predetermined condition is satisfied.
Clause 10. The information processing device according to claim 8, wherein
   when the second calculator writes the polynomial expression in the second storage, the second calculator overwrites the previously written polynomial expression in the second storage.
Clause 11. The information processing device according to claim 7, wherein
   a process of calculating the intermediate value from the seed includes a part of a process for a hash function.
Clause 12. The information processing device according to claim 11, wherein
   a process of calculating the polynomial expression from the intermediate value includes another part of the process for the hash function.
Clause 13. The information processing device according to claim 12, wherein
   the part of the process for the hash function includes an absorption process for the hash function, and
   the other part of the partial process for the hash function includes a squeeze process for the hash function.
Clause 14. The information processing device according to claim 7, wherein
   the first calculator calculates the intermediate values for X elements of a plurality of elements in the matrix, and
   the signature candidate generator is configured to:
      when the selected element is one of the X elements, read the intermediate value from the first storage for the selected element and calculate the polynomial expression from the intermediate value, and
      when the selected element is one of Y elements that are of the plurality of elements in the matrix and that are other than the X elements, calculate the polynomial expression for the selected element from the seed and perform computation based on the calculated polynomial expression, and
      generate the signature candidate based on the result of the computation.
Clause 15. The information processing device according to claim 14, further comprising:
   a second calculator configured to calculate a polynomial expression from the intermediate value for the selected element that is one of the X elements and calculate the polynomial expression from the seed for the selected element that is one of the Y elements, and
   a second storage configured to store the polynomial expression calculated by the second calculator, wherein
   the second calculator writes the polynomial expression in the second storage, whenever the second calculator calculates the polynomial expression, and
   the signature candidate generator acquires the polynomial expression for the selected element by reading the polynomial expression from the second storage.
Clause 16. The information processing device according to claim 9, wherein
   the first calculator calculates the seed from a private key,
   the signature candidate generator performs a process based on data that is a signature object, in the computation based on the polynomial expression, and
   the signature candidate generator generates a digital signature based on the signature candidate for which it is determined that the predetermined condition is not satisfied.
Clause 17. An information processing method comprising:
   calculating first polynomial expressions from a seed for X elements of a plurality of elements in a matrix;
   writing the calculated first polynomial expressions into a first storage;
   sequentially selecting the plurality of elements; and
   when the selected element is one of the X elements, reading the corresponding first polynomial expression from the first storage and performing computation based on the first polynomial expression, and
   when the selected element is one of Y elements other than the X elements, calculating a second polynomial expression for the selected element from the seed and performing computation based on the second polynomial expression,
   wherein a signature candidate is generated based on a result of the computation.
Clause 18. An information processing method comprising:
   calculating intermediate values from a seed for a plurality of elements in a matrix;
   writing the calculated intermediate values into a first storage;
   sequentially selecting the plurality of elements;
   calculating a polynomial expression from the intermediate value read from the first storage for the selected element and performing computation based on the polynomial expression,
   wherein a signature candidate is generated based on a result of the computation.

1. An information processing device comprising:
a first calculator configured to calculate first polynomial expressions from a seed, for X elements of a plurality of elements in a matrix;
a first storage configured to store the first polynomial expressions calculated by the first calculator; and
a signature candidate generator configured to
sequentially select the plurality of elements and
when the selected element is one of the X elements, read the corresponding first polynomial expression from the first storage and perform computation based on the first polynomial expression; and
when the selected element is one of Y elements other than the X elements, calculate a second polynomial expression for the selected element from the seed and perform computation based on the second polynomial expression,
wherein the signature candidate is generated based on the result of the computation.

2. The information processing device according to claim 1, comprising a second calculator configured to calculate a second polynomial expression from the seed, for a designated element of the plurality of elements, wherein
the signature candidate generator designates the selected element when the selected element is one of the Y elements, and
the second calculator calculates the second polynomial expression for the selected element.

3. The information processing device according to claim 1, wherein
the signature candidate generator determines whether a predetermined condition relevant to the signature candidate is satisfied, and repeats the generation of the signature candidate again when the predetermined condition is satisfied.

4. The information processing device according to claim 2, further comprising a second storage configured to store the second polynomial expression calculated by the second calculator, wherein
the second calculator writes the second polynomial expression in the second storage whenever the second calculator calculates the second polynomial expression, and
the signature candidate generator acquires the second polynomial expression by reading the second polynomial expression from the second storage.

5. The information processing device according to claim 4, wherein
when the second calculator writes the second polynomial expression in the second storage, the second calculator overwrites the previously written second polynomial expression in the second storage.

6. The information processing device according to claim 3, wherein
the first calculator calculates the seed from a private key,
the signature candidate generator performs a process based on data that is a signature object, in the computation based on the first polynomial expression and in the computation based on the second polynomial expression, and
the signature candidate generator generates a digital signature based on the signature candidate for which it is determined that the predetermined condition is not satisfied.

7. An information processing device comprising:
a first calculator configured to calculate intermediate values from a seed, for a plurality of elements in a matrix;
a first storage configure to store the plurality of intermediate values calculated by the first calculator; and
a signature candidate generator configured to sequentially select the plurality of elements, and to generate a signature candidate by calculating a polynomial expression from the intermediate value read from the first storage for the selected element and executing computation based on the polynomial expression.

8. The information processing device according to claim 7, further comprising:
a second calculator configured to calculate a polynomial expression from the intermediate value, for the selected element; and
a second storage configured to store the polynomial expression calculated by the second calculator, wherein
the second calculator writes the polynomial expression in the second storage, whenever the second calculator calculates the polynomial expression, and
the signature candidate generator acquires the polynomial expression by reading the polynomial expression from the second storage.

9. The information processing device according to claim 7, wherein
the signature candidate generator determines whether a predetermined condition relevant to the signature candidate is satisfied, and repeats the generation of the signature candidate again when the predetermined condition is satisfied.

10. The information processing device according to claim 8, wherein
when the second calculator writes the polynomial expression in the second storage, the second calculator overwrites the previously written polynomial expression in the second storage.

11. The information processing device according to claim 7, wherein
a process of calculating the intermediate value from the seed includes a part of a process for a hash function.

12. The information processing device according to claim 11, wherein
a process of calculating the polynomial expression from the intermediate value includes another part of the process for the hash function.

13. The information processing device according to claim 12, wherein
the part of the process for the hash function includes an absorption process for the hash function, and
the other part of the partial process for the hash function includes a squeeze process for the hash function.

14. The information processing device according to claim 7, wherein
the first calculator calculates the intermediate values for X elements of a plurality of elements in the matrix, and
the signature candidate generator is configured to:
when the selected element is one of the X elements, read the intermediate value from the first storage for the selected element and calculate the polynomial expression from the intermediate value, and
when the selected element is one of Y elements that are of the plurality of elements in the matrix and that are other than the X elements, calculate the polynomial expression for the selected element from the seed and perform computation based on the calculated polynomial expression, and
generate the signature candidate based on the result of the computation.

15. The information processing device according to claim 14, further comprising:
a second calculator configured to calculate a polynomial expression from the intermediate value for the selected element that is one of the X elements and calculate the polynomial expression from the seed for the selected element that is one of the Y elements, and
a second storage configured to store the polynomial expression calculated by the second calculator, wherein
the second calculator writes the polynomial expression in the second storage, whenever the second calculator calculates the polynomial expression, and
the signature candidate generator acquires the polynomial expression for the selected element by reading the polynomial expression from the second storage.

16. The information processing device according to claim 9, wherein
the first calculator calculates the seed from a private key,
the signature candidate generator performs a process based on data that is a signature object, in the computation based on the polynomial expression, and
the signature candidate generator generates a digital signature based on the signature candidate for which it is determined that the predetermined condition is not satisfied.

17. An information processing method comprising:
calculating first polynomial expressions from a seed for X elements of a plurality of elements in a matrix;
writing the calculated first polynomial expressions into a first storage;
sequentially selecting the plurality of elements; and
when the selected element is one of the X elements, reading the corresponding first polynomial expression from the first storage and performing computation based on the first polynomial expression, and
when the selected element is one of Y elements other than the X elements, calculating a second polynomial expression for the selected element from the seed and performing computation based on the second polynomial expression,
wherein a signature candidate is generated based on a result of the computation.

18. An information processing method comprising:
calculating intermediate values from a seed for a plurality of elements in a matrix;
writing the calculated intermediate values into a first storage;
sequentially selecting the plurality of elements;
calculating a polynomial expression from the intermediate value read from the first storage for the selected element and performing computation based on the polynomial expression,
wherein a signature candidate is generated based on a result of the computation.
